(19) United States
(12) Patent Application Publication
(10) Pub. No.: US 2024/0012219 A1
(43) Pub. Date: Jan. 11, 2024

(54) UTILITY POLES AND TENSION ADJUSTMENT METHOD FOR OPTICAL CABLES

(71) Applicant: NIPPON TELEGRAPH AND TELEPHONE CORPORATION, Tokyo (JP)

(72) Inventors: Wataru KOKUBO, Musashino-shi, Tokyo (JP); Yoshiyasu SATO, Musashino-shi, Tokyo (JP); Tatsuya MOKI, Musashino-shi, Tokyo (JP); Hidenobu HIROTA, Musashino-shi, Tokyo (JP); Kenji INOUE, Musashino-shi, Tokyo (JP)

(73) Assignee: NIPPON TELEGRAPH AND TELEPHONE CORPORATION, Tokyo (JP)

(21) Appl. No.: 18/035,189

(22) PCT Filed: Nov. 6, 2020
(86) PCT No.: PCT/JP2020/041460

§ 371 Date: May 3, 2023

(51) Int. Cl. G02B 6/48

(52) U.S. Cl. CPC G02B 6/483

(57) ABSTRACT

An object of the present disclosure is to make it possible to adjust a balance of tension applied to an optical cable fixed to a utility pole.

A disclosed utility pole includes: a through hole (12) that is disposed on an upper side of a utility pole (10) and through which optical cable (21) can pass; and a cap (22) disposed in a gap between the through hole (12) and the optical cable (21), in which the cap (22) is fixed to the through hole (12).

### TECHNICAL FIELD

The present disclosure relates to a utility pole and a tension adjusting method for an optical cable.

### BACKGROUND ART

Many optical cables for power systems and communication systems are wired on utility poles (Non Patent Literature 1). Since cables are heavy (Non Patent Literature 2), the utility poles that support the cables are required to be high-strength structures. Therefore, the utility poles are made of concrete and steel material (Non Patent Literature 3). The concrete and the steel materials are the same as those in members of high-rise buildings. In order to wire the optical cable outdoors, like in utility poles 91 and 94 illustrated in FIG. 7, an optical cable 21 is wired by fixing hardware 112 to the utility pole and fixing the optical cable 21 to the hardware 112.

Originally, the utility pole stands in the vertical direction, but when a tension difference occurs between both sides in the longitudinal direction of the optical cable, the utility pole loses its balance and inclines obliquely. When the utility pole is inclined, the utility pole itself bends, and cracks may be generated on the surface of the utility pole. It has been identified that when moisture enters the inside of the utility pole from these cracks, the steel material corrodes, the strength of the utility pole decreases, and the utility pole may break. When one utility pole loses its balance, the tension applied to the optical cable unbalances the adjacent utility pole, which adversely affects the utility poles in that area.

In the current method, there is only a method of temporarily completely removing the optical cable from the hardware, and fixing the optical cable to the hardware again while checking the balance of the utility pole. In order to completely remove the optical cable from the hardware, the operator needs to hold the optical cable in midair while supporting the optical cable by hand, which is considered to be a work that cannot be practically performed.

### CITATION LIST

### Non Patent Literature

Non Patent Literature 1: Haruhito Funaki, 2nd Communication network to protect the island, 423 island lifeline, NTT East Corporate Information, NTT East, https://www.ntt-east.co.jp/universal/web2-4.html
Non Patent Literature 2: Nippon Seisen Co., Ltd., Information Communication Cable General Catalog, Communication Cable, pp. 38-43, https://nscable.co.jp/wnsnp/wp-content/uploads/2018/10/nsc catalog vol? lite.pdf
Non Patent Literature 3: Tohoku Pole Co., Ltd., “Quality/Technology”, Concrete Pole Structure, Tohoku Pole Co. Ltd., HP, http://www.tohokupole.co.jp/pro tech.html

### SUMMARY OF INVENTION

### Technical Problem

An object of the present disclosure is to make it possible to adjust a balance of tension applied to an optical cable fixed to a utility pole.

### Solution to Problem

A utility pole of the present disclosure includes: a through hole that is disposed on an upper side of a utility pole and through which an optical cable is able to pass; and a cap disposed in a gap between the through hole and the optical cable and fixed to the through hole.

A tension adjusting method for an optical cable of the present disclosure includes: in an optical cable in which one place in a longitudinal direction is fixed to a through hole of a utility pole, when a tension difference occurs on both sides in the longitudinal direction of the optical cable centered on the one place, removing a cap disposed in a gap between the through hole and the optical cable from the through hole; and moving a position of the cap attached to the optical cable in the longitudinal direction of the optical cable so that the tension difference between the both sides in the longitudinal direction of the optical cable is reduced.

### Advantageous Effects of Invention

According to the present disclosure, it is possible to adjust a balance of tension applied to an optical cable fixed to a utility pole.

### BRIEF DESCRIPTION OF DRAWINGS

FIG. 1 illustrates an example of a structure of a utility pole according to an embodiment.

FIG. 2 illustrates a usage example of the utility pole according to the present embodiment.

FIG. 3 illustrates an example of a structure of the utility pole according to the present embodiment.

FIG. 4 illustrates an example of fixing an optical cable.

FIG. 5 illustrates an example of a cross-sectional structure of a cap.

FIG. 6 illustrates an example of fixing an optical cable.

FIG. 7 illustrates an example of tension adjustment of an optical cable.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be carried out in forms with various modifications and improvements based on the knowledge of those skilled in the art. Note that components having the same reference signs in the present description and the drawings indicate the same components.

### First Embodiment

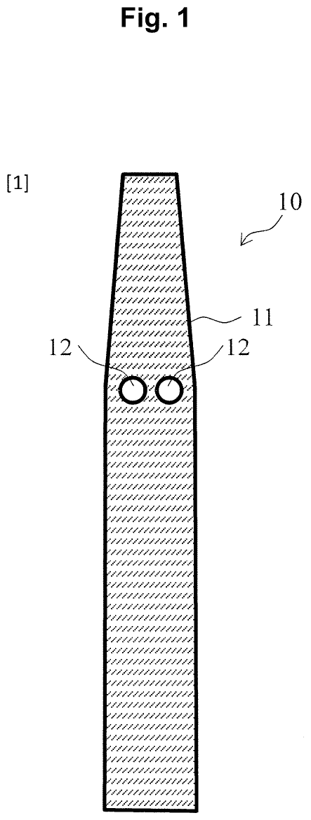

FIG. 1 illustrates an example of a structure of a utility pole according to the present embodiment. A through hole 12 is constructed in the upper portion of a pole 11 in a utility pole 10 according to the present embodiment. Conventionally, a dedicated hardware is externally attached to a utility pole to fix an optical cable, so that the through hole 12 is a large difference. A plurality of through holes 12 may be provided at the same height. Further, the through hole 12 may be provided below the center of the utility pole 10.

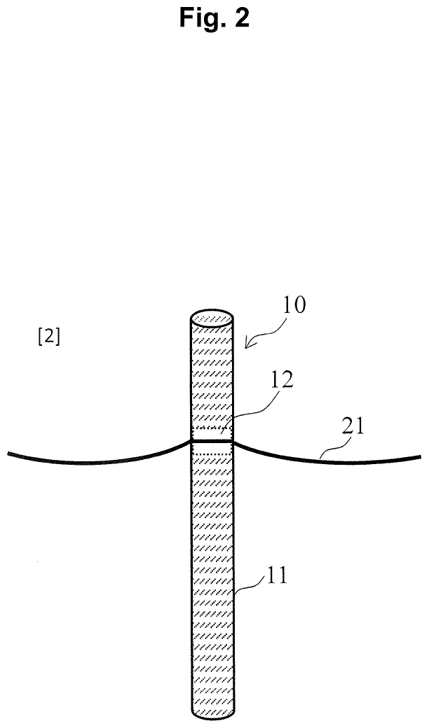

FIG. 2 illustrates a usage example of the utility pole 10 according to the present embodiment. In the utility pole 10 according to the present embodiment, an arbitrary number of one or more optical cables 21 are passed through the through hole 12. Accordingly, one place in the longitudinal direction of the optical cable 21 is fixed to the through hole 12 of the utility pole 10. In the present disclosure, since the optical cable 21 is supported by the through hole 12, the operator does not need to support the optical cable 21. Therefore, the present disclosure makes it possible to adjust the balance of the tension applied to the optical cable 21 fixed to the utility pole 10.

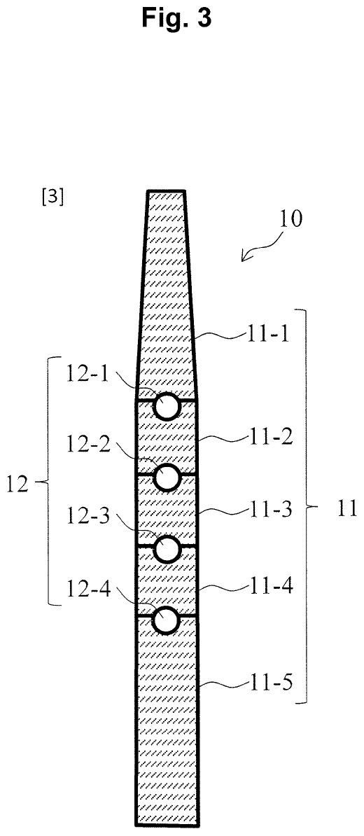

FIG. 3 illustrates an example in which a plurality of through holes 12-1, 12-2, 12-3, and 12-4 are provided. By increasing the number of through holes 12, the number of optical cables 21 can be increased. In addition, in order to facilitate replacement of the optical cable 21 and the utility pole 10, as illustrated in FIG. 3, the utility pole 10 may have a structure in which the utility pole is divisible into poles 11-1, 11-2, 11-3, 11-4, and 11-5 at the portion of the through hole 12. The divisible position may be above the center of the through hole 12.

### Second Embodiment

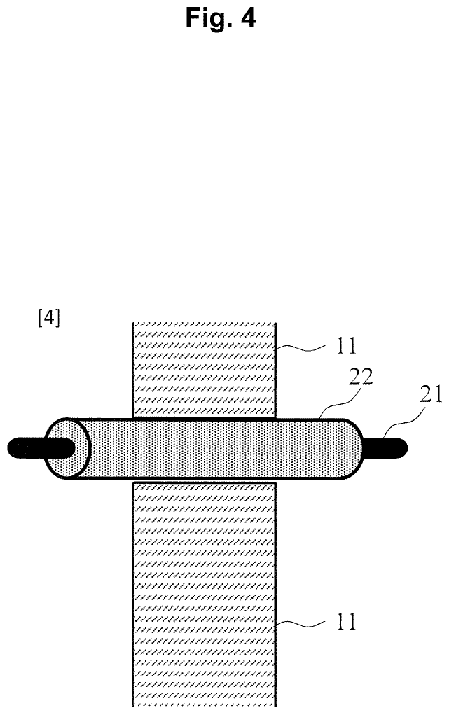

FIG. 4 illustrates a method of fixing an optical cable. If a gap is formed between the through hole 12 and the optical cable 21, the optical cable 21 cannot be completely fixed to the pole 11. Therefore, the present embodiment includes a cap 22 that fills the gap of the through hole 12 and fixes the optical cable 21 to the pole 11.

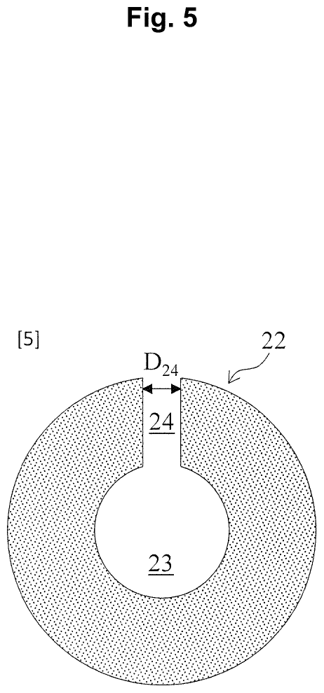

FIG. 5 illustrates an example of a cross-sectional structure of the cap 22. The cap 22 includes a space 23 in which the optical cable 21 is disposed and a notch 24 reaching the space 23. A width D₂₄ of the notch 24 has any value perceivable by the human eye or finger.

The inner diameter of the space 23 is equal to or smaller than the outer diameter of the optical cable 21 so that the optical cable 21 can be held. In addition, the inner surface of the space 23 may be processed to have a large friction with respect to the outer cover of the optical cable 21 so that the optical cable 21 does not slide and move. This friction is a frictional force allowing movement in the longitudinal direction of the optical cable 21, when a certain amount of force or more allowed in the outer cover of the optical cable 21 is applied in the longitudinal direction of the optical cable 21.

The outer diameter of the cap 22 is equal to or larger than the diameter of the through hole 12 so that the cap 22 is fixed to the through hole 12. When the through hole 12 has an oval shape, the outer diameter of the cap 22 is adjusted to the diameter in the lateral direction. Further, the outer surface of the cap 22 may be processed to have a large friction with the inner wall surface of the through hole 12 so that the cap 22 does not slide and move in the through hole 12.

The magnitude of friction with the optical cable 21 on the inner surface of the space 23 is preferably smaller than the magnitude of friction with the inner wall surface of the through hole 12 on the outer surface of the cap 22. Further, the cap 22 may be provided with a mechanism for detachably fixing to the pole 11.

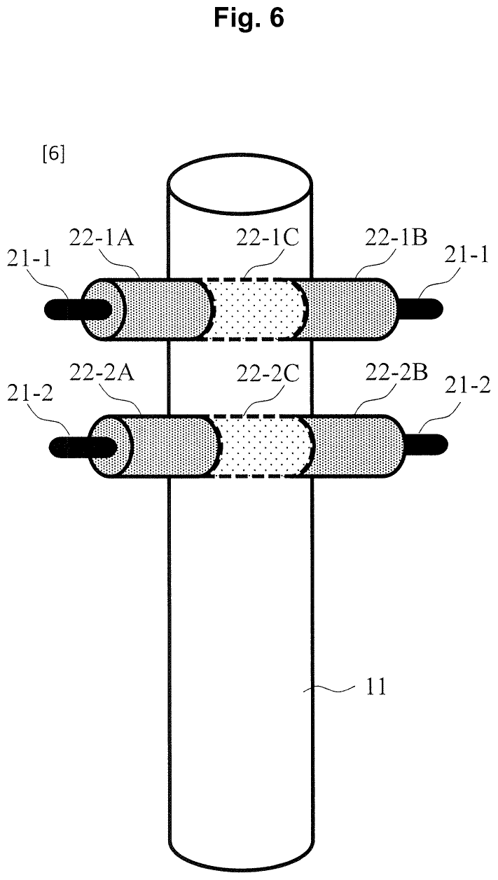

As illustrated in FIG. 6, a plurality of caps 22-1A and 22-1B may be attached to one optical cable 21-1. In addition, when a plurality of optical cables 21-1 and 21-2 are attached to one pole 11, caps 22-1A and 22-1B and caps 22-2A and 22-2B are attached to the optical cables 21-1 and 21-2, respectively. In this case, the outer diameters of the caps 22-1A and 22-1B may be larger than the outer diameter of a cap 22-1C.

### Third Embodiment

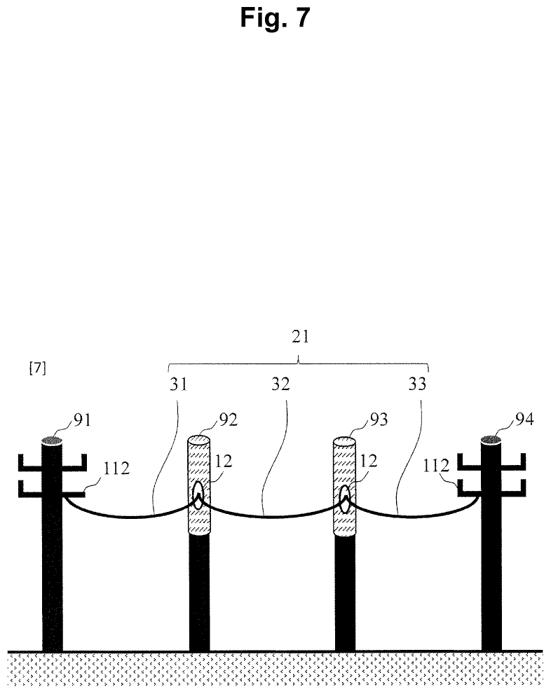

FIG. 7 illustrates a system of utility poles in which two utility poles according to the present embodiment are disposed. Utility poles 91, 92, 93, and 94 are connected by an optical cable 21. Not all the utility poles 91, 92, 93, and 94 are the utility poles 10 of the present disclosure, and even when the utility poles 10 of the present disclosure are used for some of the utility poles 92 and 93 arranged, the effect of the tension adjusting method of the present disclosure can be obtained.

For example, when the tension of the optical cable 21 is out of balance and the utility pole 91 starts to bend, the cap is removed from the utility pole 92. Here, the cap is reference numeral 22 illustrated in FIG. 4 or reference numerals 22-1A and 22-1B illustrated in FIG. 6 described in the second embodiment. Then, the position of the cap attached to the optical cable 21 is changed. At this time, the position of the cap attached to the optical cable 21 is moved in the longitudinal direction of the optical cable 21 so that the tension difference between optical cables 31 and 32 is reduced. The same applies to optical cables 32 and 33 fixed to the utility pole 93.

Here, in the present disclosure, since the optical cable 21 after the cap is removed is supported by the through hole 12, the operator does not need to support the optical cable 21. Both caps of the utility poles 92 and 93 can also be removed from the utility poles 92 and 93 to balance the optical cables 31, 32, and 33. Thereby, in the utility pole and the tension adjusting method of the present disclosure, the deflection amount of the optical cables 31, 32, and 33 can be easily changed, so that the tension can be changed. That is, the balance of the utility pole 91 can be appropriately restored.

### INDUSTRIAL APPLICABILITY

The present disclosure can be applied to information and communication industries.

### REFERENCE SIGNS LIST

10, 91, 92, 93, 94 Utility pole
11, 11-1, 11-2, 11-3, 11-4, 11-5 Pole
12, 12-1, 12-2, 12-3, 12-4 Through hole
21, 21-1, 21-2, 31, 32, 33 Optical cable
22, 22-1A, 22-1B, 22-2A, 22-2B Cap
112 Hardware

1. A utility pole comprising:
a through hole that is disposed on an upper side of a utility pole and through which an optical cable is able to pass; and
a cap disposed in a gap between the through hole and the optical cable and fixed to the through hole.

2. The utility pole according to claim 1, wherein the cap is attachable to and detachable from the utility pole, and is movable in a longitudinal direction of the optical cable.

3. The utility pole according to claim 1,
wherein a plurality of the through holes are provided, and
the utility pole is divisible in at least any one of the through holes.

4. A tension adjusting method for an optical cable, comprising:
in an optical cable in which one place in a longitudinal direction is fixed to a through hole of a utility pole, when a tension difference occurs on both sides in the longitudinal direction of the optical cable centered on the one place,
removing a cap disposed in a gap between the through hole and the optical cable from the through hole; and
moving a position of the cap attached to the optical cable in the longitudinal direction of the optical cable so that the tension difference between the both sides in the longitudinal direction of the optical cable is reduced.
